(19) United States
(12) Patent Application Publication
(10) Pub. No.: US 2006/0206387 A1
(43) Pub. Date: Sep. 14, 2006

(54) Transportation planning with multi-level firming

(75) Inventors: Roy Isaac Peterkofsky, San Francisco, CA (US); Hema Budaraju, Fremont, CA (US); Atul Kumar Srivastav, Hyderabad (IN); Rekha Rani Argula, Hyderabad (IN); Vijay Pillarisetti, Fremont, CA (US); Quan Lu, San Diego, CA (US); Rongming Sun, Hayward, CA (US)

Correspondence Address: MCDONALD HOPKINS CO., LPA, 600 SUPERIOR AVE., E., SUITE 2100, CLEVELAND, OH, 44114, US

(73) Assignee: Oracle International Corporation, RED WOOD SHORES, CA (US)

(21) Appl. No.: 11/078,675

(22) Filed: Mar. 11, 2005

(51) Int. Cl. G06G 1/14

(52) U.S. Cl. 705/22

(57) ABSTRACT

Systems, methodologies, media, and other embodiments associated with transportation planning with multi-level firming are described. One exemplary computer-implemented method embodiment includes accessing transportation planning elements and a transportation planning model. The method may also include identifying loads that satisfy orders in the transportation planning elements according to constraints in the transportation planning model and then applying multi-level firming designations to transportation planning elements related to the identified loads. The method may also include identifying additional loads based, at least in part, on the multi-level firming designations. The method may output an actionable plan of loads stored, for example, on a computer-readable medium.

### BACKGROUND

Transportation planning systems and methods may attempt to minimize transportation costs through actions like load consolidation, continuous moves, selecting carriage mode, selecting carrier, and so on. Transportation planning systems and methods may also attempt to improve situations like on-time delivery, customer satisfaction, compliance with routing guides, usage of preferred carriers, usage of volume-based pricing, and so on. At times these may produce conflicting and/or competing goals. Thus, transportation planning systems and methods may be configured to selectively make trade-offs in order to maximize, for example, an overall utility.

A transportation management system may include components like a planning component and an execution component. The planning component may perform tasks like consolidating orders into shipments, assigning shipments to loads, selecting load routes, selecting carriers, determining the order in which shipments are loaded on a truck, and so on. The results of these tasks may be recorded, for example, in a plan. The plan may be communicated to the execution component. The execution component may then perform tasks like rating, tendering, booking, tracing/tracking, and so on. However, an automatically produced static plan may include suboptimal loads because the automatic planning algorithms may not be able to consider all factors involved in planning adequately. Furthermore, a static plan may need to be reworked in response to late arriving orders, cancelled orders, and other changing conditions. Thus, transportation management system planning components may be configured to rework an existing plan. Unfortunately, reworking an existing plan may require revisiting decisions already made and reprocessing data already processed. In some cases this may lead to compromising good planning decisions already made (e.g., highly utilized truck on a good route). In some examples, where a user has manually overridden a decision made by an automated system or method, a subsequent automated decision may undo the manual override. Furthermore, automated planning systems and methods may change previous decisions even if actions (e.g., tendering, carrying, delivering) have been taken based on the previous decision. Clearly this may be undesirable.

Transportation planning may be performed, for example, by companies (e.g., shippers) that interact with carriers. Unique elements of the North American regional transportation system lead to extensive truck utilization and thus transportation planning may facilitate interacting with truck based carriers. The unique elements include long distances between major cities, an extensive high quality, government subsidized road network, relatively low fuel costs, a highly organized and competitive trucking industry, comparatively poor rail service over a relatively limited rail network, and a high level of economic activity over very dense traffic lanes. Thus, systems and methods that participate in truck based transportation planning may facilitate mitigating some inefficiencies associated with transportation planning.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example method associated with transportation planning with multi-level firming.

FIG. 2 illustrates another example method associated with transportation planning with multi-level firming.

FIG. 3 illustrates an example system associated with transportation planning with multi-level firming.

FIG. 4 illustrates another example system associated with transportation planning with multi-level firming.

FIG. 5 illustrates an example computing environment in which example systems and methods illustrated herein can operate.

FIG. 6 illustrates an example method associated with a graphical user interface.

FIG. 7 illustrates an example application programming interface (API).

### DETAILED DESCRIPTION

Example systems, methods, media, and other embodiments described herein relate to transportation planning with multi-level firming. Example systems and methods may facilitate interacting with carriers like package carriers (e.g., UPS), less than truckload (LTL) carriers, truckload carriers (TL) and so on. In one example, computer-based systems and methods facilitate accessing transportation planning data like orders, shipments, loads, and so on. The example systems and methods may also facilitate accessing a transportation planning model that includes data concerning routes, carriers, the transportation network, and so on. With the planning data and the planning model available, example systems and methods may then facilitate identifying loads (e.g., vehicle, driver, contents, route, stops, itinerary) that satisfy orders. After determining some loads, the example systems and methods may include assigning multi-level firming designations to transportation planning data affected by the loads and then reprocessing the transportation planning data to find additional loads in light of the multi-level firming designations. In one example, loads may then be tendered to a carrier.

The multi-level firming designations facilitate accommodating transportation planning situations where it may be desirable to maintain some loads, shipments, attributes associated with a load, and/or attributes associated with a shipment in particular state(s) (e.g., route, schedule, carrier, contents). Example systems and methods may therefore be configured to treat certain load and/or shipment attributes as immutable. By way of illustration, if a load has been tendered to a carrier and is in transit, then example systems and methods may be configured to not change the load attributes when re-optimizing other loads. In some cases, example systems and methods may be configured to not change the attributes of shipments assigned to loads when re-optimizing other loads and shipments. By way of further illustration, a load may have been optimized to a desired threshold in an earlier planning cycle and thus example systems and methods may be configured to not replan that load when re-optimizing other loads. While a load may be firmed and thus “off-limits” during re-optimizing, data associated with the load may need to be considered by example systems and methods when planning and/or optimizing other loads. For example, if a carrier offers a volume discount for booking a certain number of loads, firmed loads may contribute to reaching the threshold for the discount and thus should be examined when planning and/or re-optimizing remaining loads, even while the firmed loads themselves remain firmed and thus immutable.

Conventionally, if firming decisions were made at all they were binary. Either a load or shipment was firmed or it was not firmed. Either the load or shipment could be changed in all of its attributes or it could be changed in none of its attributes. However, the dynamic transportation planning environment is complex and not accurately modeled with binary variables, particularly in light of last-minute demand changes, unpredictable congestion at transportation facilities, and so on. As an example of the complexity in the modern business world, consider a situation where a plan may include loads with one firmed attribute (e.g., route) while other attributes remain not firmed (e.g., shipments assigned to a load). By way of illustration, example systems and methods may be configured to firm the route while leaving the contents mutable and thus allow a shipment to be added or removed from the load in the plan while the route of the load itself must remain unchanged. By way of further illustration, example systems and methods may be configured to consolidate a set of orders so they travel together. Thus, an order consolidation may be firmed in a plan while the route, carrier, and other elements of a load involving the order consolidation may be open to change.

In the absence of firming, re-planning loads and/or re-optimizing a plan may have unintended and undesirable consequences. For example, a first process that planned and optimized one thousand orders may have produced one hundred optimized loads with very desirable attributes like greater than 95% truck utilization, volume discount achieved, preferred carrier selected, just in time delivery achieved, and so on. However, after receiving an additional fifty late-arriving orders after the planning was complete, conventional planning systems may have re-worked the entire plan and compromised some of the original optimized loads. For example, truck utilization may be reduced, a volume discount may be lost, less preferable carriers may be selected, and so on. Thus, it may be desirable to facilitate “fixing” portions of a plan like the optimized loads with very desirable attributes while letting other portions of a plan be re-planned and/or re-optimized.

With example systems and methods providing multi-level firming, some loads and/or shipments may be firmed so that neither route nor contents nor other attributes may be changed. Other loads and/or shipments may be firmed with respect to contents while others may be firmed with respect to route, and so on. Thus, when re-optimizing a plan due, for example, to receiving additional late-arriving orders, and/or having an order(s) cancelled, example systems and methods may be controlled to “optimize around” certain items like firmed loads and/or shipments, partially firmed loads and/or shipments, and so on, while still considering the data in these loads and/or shipments.

Multi-level firming allows a user to flexibly specify various firming levels to be applied to various plan elements. Example firming levels may include, but are not limited to, routing and contents firm, routing firm, routing firm with removal of shipments not allowed, contents firm, soft firm, and not firmed.

Routing and contents firm may refer to fixing attributes about a load and/or shipment. The fixed attributes may include, for example, route, schedule, carrier, shipment-to-load assignments, and so on. In one example, the shipments assigned to a load may not be changed and thus no additional shipments may be added to the load and no shipments may be removed from the load and the itineraries of the shipments assigned to the load may not be changed. This level may be employed, for example, when a highly optimized load (e.g., 95% truck utilization, on-time delivery, preferences satisfied) has been produced by manual editing after an initial optimization and the planner wants to insure the load is not reworked by a subsequent re-optimization and that shipments manually assigned to the load are not automatically assigned to other loads.

Routing firm may refer to a load whose routing attributes (e.g., route, schedule, carrier) may not be changed but for which other attributes (e.g., shipments) may be changed. In one example, shipments assigned to a load may be unassigned and/or new shipments may be assigned to a load. Routing firm may be appropriate in situations where routing instructions (e.g., pickup time, stops, drop off times) have been communicated and committed to a carrier but the carrier is unconcerned about (un)loading activity at the stops.

Routing firm with removal of shipment not allowed may refer to a load whose routing attributes (e.g., route, schedule, carrier) may not be changed and from which shipments may not be removed but to which additional shipments may be added. Routing firm with shipment removal may be appropriate in situations where an acceptable load exists, perhaps a load that was manually manipulated, and where the load may be improved upon by adding an additional shipment but where the planner does not want to risk compromising the already acceptable load during a re-optimization by losing the shipments that were manually assigned to it.

Contents firm may refer to a consolidated shipment whose shipment attributes (e.g., consolidated orders) may not be changed but whose routing attributes (e.g., route, schedule, carrier, itinerary) may be changed. Contents firm may be appropriate when a planner wants to keep certain elements of an order(s) traveling together (e.g., computer processors, monitors, and keyboards) but has flexibility concerning how and when they are delivered. The flexibility may facilitate, for example, finding more optimal routings on different days or by different carriers.

Soft firm may refer to loads and/or shipments for which an optimizing logic is configured to treat plan elements that have been manual edited by a planner as firm even if the user did not explicitly apply a firming level to the plan element(s). This facilitates a user examining “what-if” opportunities without losing manual edits and while not making a permanent firming decision.

Not firmed may be a default situation and/or a user selected situation where route attributes (e.g., origin, destination, stops, times) may be changed as well as the shipment attributes (e.g., assigned/consolidated orders, loading order).

In one example, application of multi-level firming may require coordinating the firming levels applied to different loads, shipments, and so on to facilitate maintaining mutual consistency between the firming levels. For example, designating that the itinerary of a shipment cannot change may also require that the load(s) associated with the shipment(s) is/are also immutable. Additionally, designating that the contents of a load cannot change may also require that the itineraries of shipments assigned to that load are also immutable. These are but two example relationships and dependencies between entities to which multi-level firming designations may be applied. Thus, example systems and methods may include logic for propagating changes in firming levels from one entity to a related entity and logic for maintaining consistency between these changeable multi-level designations.

As well as establishing firming levels for plan elements, example systems and methods may facilitate establishing optimization settings for (re)running a plan (e.g., (re)optimizing a plan), where the optimization settings control the interpretation of and/or reaction to plan element firming levels. For example, a planner may specify that a load that is routing and contents firm should be maintained as-is in the (re)optimization but that its attributes should be considered when making other (re)optimization decisions. In another example, a planner may specify that a load that has been manually edited by the planner should be treated as routing and contents firm. Thus, a planning logic may maintain the schedule and contents of a previously manually edited load. This may implement, for example, the soft firm level. In another example, the planner may specify that for loads whose routing is firm, the route, the origin, the start time, the destination, and the delivery time(s) should remain firm but deliveries may be added to the load subject to the constraints of the route and schedule. Thus, in different examples multi-level firming may be applied on a plan element basis and/or a plan basis.

Consider a plan having a planning horizon of four days with five hundred loads, one hundred of which have already been tendered and which should, therefore, not have their routing and/or contents changed in a subsequent re-optimization. Assume that another fifty loads are routing firm while fifty of the shipments to be routed on these loads are contents firm. In a conventional system, a planner may be required to manually analyze each of these already firmed loads to determine whether the loads maintained their status and attributes after a re-optimization. This could lead to unacceptable planning time sinks that compromise the ability of the planning systems and methods to satisfy deadlines. Alternatively, a planner may be forced to forego using conventional automated replanning, requiring changes to a plan necessitated by the changes to the underlying orders to be reflected manually. This may not only compromise the timing of the planning process but may also result in abandoning automated planning. Thus, example systems and methods may facilitate “optimizing around” the firmed loads (e.g., tendered loads, routing firm loads, contents firm loads) to identify further optimizations in the still not firm loads while considering the data associated with the firmed loads. In re-optimizations, with selected firming applied to plan elements, the problem space (e.g., set of data still to be analyzed for load possibilities) for an optimization logic will shrink as fewer shipments, routes, and loads need to be considered. Thus re-optimization time will shrink as more and more loads are firmed and the problem space continues to shrink. This facilitates responding quickly to changes made late in a planning cycle and thus facilitates accepting, for example, last minute orders without compromising already issued instructions.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity like hardware, firmware, software, software in execution, and/or a combination thereof. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer communication”, as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, semiconductor memories, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM (random access memory), a ROM (read only memory), an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

Elements illustrated in the flow diagrams denote “processing blocks” that may be implemented in logic. In one example, the processing blocks may represent executable instructions that cause a computer, processor, and/or logic device to respond, to perform an action(s), to change states, and/or to make decisions. Thus, the described methodologies can be implemented as processor executable instructions and/or operations provided by a computer-readable medium. In another example, the processing blocks may represent functions and/or actions performed by functionally equivalent circuits such as an analog circuit, a digital signal processor circuit, an application specific integrated circuit (ASIC), or other logic device.

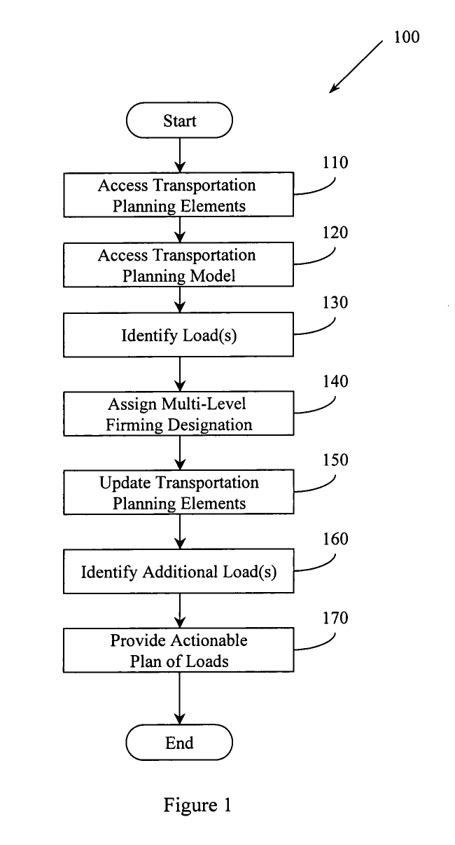

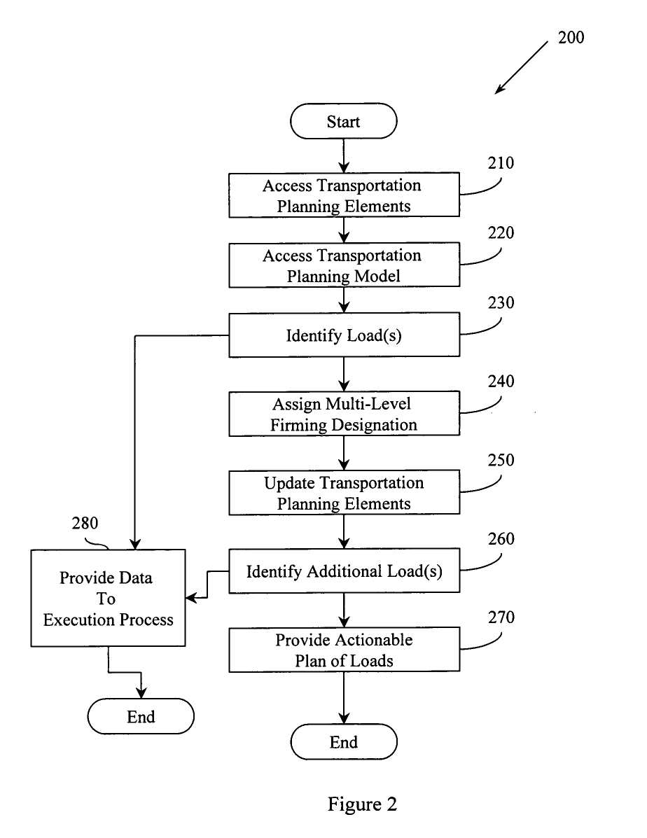

The flow diagrams of FIGS. 1 and 2, are not intended to limit the implementation of the described examples. Rather, the diagrams illustrate functional information one skilled in the art could use to design/fabricate circuits, generate software, or use a combination of hardware and software to perform the illustrated processing. It will be appreciated that electronic and software applications may involve dynamic and flexible processes and thus blocks may be performed concurrently, substantially in parallel, and/or at substantially different points in time.

FIG. 1 illustrates an example computer-implemented method 100 associated with transportation planning with multi-level firming. As used herein, transportation planning refers to computer-based determining of how and when to ship items using vehicles like trucks. Transportation planning may include planning actions and execution actions. Transportation planning may be engaged in by entities that interact with carriers. While vehicles like trucks are described, it is to be appreciated that example systems and methods may facilitate planning for carriers using other vehicles like trains, airplanes, and so on.

Method 100 may include, at 110, accessing a set of transportation planning elements. The elements may include, for example, data concerning orders, shipments, loads, order requirements and so on. In some examples, method 100 may both acquire data from the set of transportation planning elements and write data to the set of transportation elements. Data concerning orders may include, for example, desired commodity, desired commodity amount, desired delivery date, and so on. Data concerning shipments may include, for example, orders, pickup time windows, delivery time windows, and so on. Data concerning loads may include, for example, arrival times, departure times, route, itinerary (e.g., set of stops and set of related arrival and departure times), carrier, cost, and so on. Orders, shipments, and/or loads may be associated with multi-level firming designations that facilitate controlling, for example, whether the data will be considered for addition to a new load or whether the orders assigned to an existing load and/or shipment can be re-assigned.

In one example, the set of transportation planning elements may be dynamically reconfigurable while example systems and methods are operating. For example, an additional order may be received, an order may be cancelled, and so on. In one example, an order cancellation may cause a multi-level firming designation associated with a transportation planning element to be changed. For example, if an order is cancelled and removing contents associated with the order will cause a load to fall below a desired utilization threshold (e.g., 75%), then a previously firmed load may be “un-firmed” to facilitate re-optimizing both the individual load and/or an overall transportation plan.

Method 100 may also include, at 120, accessing a transportation planning model that includes data concerning, for example, routes, carriers, constraints, preferences, rules, rates, facilities, and a transportation network. A route may describe, for example, a set of roads to be traversed by a vehicle. A carrier may describe, for example, a trucking company that provides the vehicle for a load. A constraint may describe, for example, commodities that are not allowed to travel together, commodities that must be carried by certain types of vehicles, commodities that may not traverse certain roads, and so on. A preference may describe, for example, a relationship between a preferred carrier and a commodity, a relationship between a preferred carrier and a route, a relationship between a preferred carrier and a region, a relationship between sets of orders, and so on. A rule may describe, for example, a maximum weight for a vehicle, a maximum number of hours per day of service for a driver, a maximum volume for a vehicle, and so on. A rate may describe, for example, how much is charged to carry a certain amount of a commodity by a certain mode (e.g., package, LTL, TL) in a certain period of time. A facility may describe, for example, the facility location, the facility operation hours, the facility capacity, and so on. The transportation network data may describe, for example, paths vehicles can traverse, transit times over those paths, costs associated with traversing the path, commodity restrictions for a path, and so on. While example constraints, preferences, rules, rates, and so on are described, it is to be appreciated that other examples may be possible.

Method 100 may also include, at 130, identifying load(s) and/or shipments that satisfy an order(s) in the set of transportation planning elements. Satisfying an order may include, for example, satisfying rules in the transportation planning model, satisfying preferences in the transportation model, satisfying order requirements, and so on. Order requirements may include, for example, an earliest pickup time, an earliest delivery time, a latest pickup time, a latest delivery time, a source, a destination, and so on. Thus, identifying a load that satisfies order requirements for an order(s) may include executing actions associated with consolidating, routing, and/or scheduling decisions. These actions may be selected by algorithms like a greedy algorithm, a divide and conquer algorithm, a look ahead algorithm, a dynamic programming algorithm, a linear programming algorithm, a branch and bound algorithm, a savings based algorithm, a heuristic based algorithm, and so on. These algorithms are discussed below.

Method 100 may also include, at 140, assigning a multi-level firming designation to a transportation planning element associated with a load. In one example, the available multi-level firming designations may include routing and contents firm, routing firm, contents firm, routing firm additions allowed, soft firm, and not firm. Examples of these firming levels were described above.

Method 100 may also include, at 150, updating the set of transportation planning elements with the one or more loads and/or shipments. Updating the set may include, for example, adding data to the set, removing data from the set, and/or manipulating data in the set. In one example, a new load and/or shipment may be identified at 130 and added into the set as a new data element. In another example, an existing load and/or shipment may be amended at 130 and the amendments noted by manipulating the set. In yet another example, an existing load and/or shipment may have all its contents moved to other loads and/or shipments and thus the existing load and/or shipment may be removed from the set.

In one example, updating at 150 may also include selectively manipulating multi-level firming designations associated with transportation planning elements to facilitate maintaining mutual consistency for multi-level firming designations between related orders, shipments, loads, and so on.

Method 100 may also include, at 160, identifying additional loads that satisfy orders remaining in the set of transportation planning elements. Like action 130, identifying additional loads and/or shipments may include satisfying rules in the transportation planning model and satisfying order requirements in light of multi-level firming designations associated with data in the transportation planning elements. In one example, identifying an additional load and/or shipment may include taking actions associated with consolidating orders into shipments, assigning orders and/or shipments to a vehicle, determining a vehicle route, and determining a vehicle itinerary. The actions may be associated with algorithms like a greedy algorithm, a divide and conquer algorithm, a look ahead algorithm, a dynamic programming algorithm, a linear programming algorithm, a branch and bound algorithm, a savings based algorithm, a heuristic based algorithm, and so on, as described below.

Method 100 may also include, at 170, providing an actionable plan of loads for delivering shipments to facilities. The plan and/or portions thereof may be provided, for example, to a set of carriers. In one example, the actionable plan may include data like a load contents, a load route, a load itinerary, and so on. The actionable plan may be provided, for example, on a computer-readable medium like a disk, a CD, a DVD, and so on. In one example, the actionable plan and/or portions thereof may be distributed to a carrier by, for example, the Internet. In this case, the computer-readable medium may take the form of a carrier wave. The loads may be described by data including, for example, a load start time, a load start location, a sequenced set of stops, a set of shipments involved in the load, and so on. It is to be appreciated that in some examples a load may include multiple stops, that some items may be dropped off at a stop and that other items may be picked up at a stop.

As is known in the art, there are a variety of algorithms and processes by which items can be selected to be included or not included in a group like a consolidated order. Similarly, there are a variety of algorithms and processes by which routes for loads can be selected. However, these algorithms conventionally may not have been configured to consider some data as visible but immutable in certain situations. Thus, example systems and methods may update algorithms and/or processes to alter their decision making processes to include the ability to see data but not change that data.

When presented with a set of orders, many possible solutions for consolidation, routing, load assignment, and so on may be available. Logically, as the number of items that need to be considered to determine a solution decreases so too will the time to determine the solution. By firming certain plan elements, the number of items considered can be reduced and thus subsequent re-optimizations may proceed more quickly. Conventional programming techniques associated with transportation planning may not have been able to fix or firm plan elements while still considering the firmed data for issues like dock capacity, minimum volume commitments, finite trailer availability, and so on. Thus, when any re-optimization occurred, the entire problem space including all plan elements may have had to have been considered. Therefore, there would be no reduction in processing time in subsequent calculations and various desirable elements introduced manually into an earlier automated plan may have been lost in the subsequent calculations. By contrast, example systems may facilitate early pruning of decision trees and thus reducing the size of the solution space remaining to be processed.

Example systems and methods described herein may include identifying and solving sub-problems. The sub-problems may include, for example, grouping multiple delivery lines into a single delivery, generating itineraries for deliveries, identifying pooling points for deliveries, determining whether a delivery can be broken into multiple legs, consolidating multiple deliveries into a single trip, determining a mode (e.g., TL, LTL, parcel) for a trip, finding a route for a trip while considering multi-stop loads and continuous moves, making a carrier-service-vehicle-mode assignment for a load, scheduling a trip, finding “highly optimized” loads, finding less highly optimized loads, finding suspect loads, and so on.

After producing an initial plan with this mix of loads, a planner may apply a first level of firming to some of the highly optimized loads, may apply a different firming level to some of the other highly optimized loads, and may apply yet another firming level to some of the less highly optimized loads. While the planner may assign firming levels, it is to be appreciated that example system and methods may be configured to automatically assign firming levels. Additionally, the planner may “touch” (e.g., manually edit) some of the less highly optimized loads to make them acceptable. These loads may be treated as routing and contents firm by a planning logic. With these plan elements firmed, the plan may be recomputed. The re-computing will be performed on a smaller set of plan elements and will therefore likely take less time. Additionally, loads that have been firmed may be tendered while the remaining loads are re-planned and/or re-optimized. In this way, parallel processing may occur in planning logics and execution logics, which parallelism may be impossible in conventional systems. Thus, multi-level firming mechanisms may fix certain decisions in a planning problem space, which facilitates reducing the solution space and thus improving optimization performance.

In some programming paradigms, the single best solution is referred to as the optimal solution. In some examples, neither the time nor the computing cycles may be available to compute an optimal solution, particularly if the number of elements to be considered is large. However, processes can be configured to operate for a given period of time and then produce the best solution computed in that time period. This is a familiar concept to real time game programmers and process control programmers. Therefore, in one example, with multi-level firming available, a planning logic may be configured to process for a period of time and to present the plan it is able to optimize in that period of time. A planner may then logically remove plan elements from the problem space by firming certain elements. The planning logic may then be restarted to work on the remaining plan elements. Since this is a smaller problem space, the planning logic may be able to find solutions that would not have been found in conventional systems in the planning horizon timeframe.

Additionally and/or alternatively, multi-level firming may facilitate dynamically switching between planning algorithms. For example, while a first plan may be determined using a first algorithm, subsequent plans may be determined using second algorithms based, for example, on the ratio of firmed plan elements to not firmed plan elements and the size of the not firmed problem space. For example, a first algorithm with a O(n) may be employed when the problem space is large and a second algorithm with a O(n²) may be employed when the problem space is smaller. The first algorithm may be the only practical algorithm given the size of the problem space while the second algorithm may become practical as the problem space is reduced. The first algorithm may be particularly adept at finding the “easy” loads to optimize and thus may be employed initially to identify these easy loads to facilitate logically removing them from the problem space. The second algorithm may be more adept at finding the “hard” loads to optimize, but may be much more computationally intensive. Thus, the second algorithm may be employed after multi-level firming has facilitated reducing the size of the problem space. The inflexibility of conventional single-level firming systems may result in a need for planners to leave additional loads unfirmed, thus mitigating the effect of processing time reductions that are available with example flexible, multi-level firming systems and methods.

While programming techniques like dynamic programming are described, it is to be appreciated that similar improvements may be made using techniques like greedy algorithms, divide and conquer algorithms, branch and bound algorithms, savings based algorithms, heuristic based algorithms, and so on. Greedy algorithms concern a general algorithm design paradigm that rests on the consideration of configurations and objective functions. A configuration describes different choices to make, different collections to assemble, different values to find, and so on. An objective function describes a score that may be assigned to candidate configurations. Thus, transportation planning may employ greedy algorithms whose objective function concerns a cost and/or utility and whose configurations describe orders, consolidations, routes, assignments, and so on. Greedy algorithms may seek to maximize or minimize the objective function. A greedy algorithm builds a solution by keeping the best result for a smaller problem and adding that result to a current sub-solution. In one example, as solutions for smaller problems are computed, multi-level firming may be employed to logically remove plan elements from the problem space so that subsequent processing may be applied to a smaller set of plan elements. Note that logically removing the plan elements from the problem space does not mean that subsequent planning will not be aware of the logically removed planned elements or loads associated therewith.

A greedy algorithm tends to make the best choice at the moment in the hope that this will lead to an optimal and/or acceptable solution in the long run. Greedy algorithms can benefit from periodic manual intervention. Thus, after a certain amount of processing, after a certain period of time, after a certain number of highly optimized loads have been found, and so on, a greedy algorithm may present a planner with a trial plan to which the planner may apply multi-level firming. Then, the greedy algorithm may be restarted and may focus its attention on the attributes of plan elements that remain variable under the regimes of various firming levels.

A look ahead algorithm does not necessarily make the best choice at the moment, but rather makes “tentative” decisions and determines the best result based on subsequent decisions. Look ahead algorithms are familiar to those involved in chess programming and tend to be more computationally intensive than greedy algorithms. However, in some cases, look ahead algorithms may find solutions that greedy algorithms may not. Thus, based on problem space manipulation associated with multi-level firming, a combination of greedy algorithms and look ahead algorithms may collaborate in iterative (re)optimization planning.

Divide and conquer programming involves breaking problems into independent sub-problems and solving the sub-problems. Linear programming is used to solve problems that involve limited resources, an overall objective, and a choice of actions to be taken. The simplex method is a pre-eminent tool in linear programming. Once again, as multi-level firming is employed to reshape the problem space, in some examples a planning logic may be configured to dynamically switch between algorithms based on the nature of the problem space. Conventional systems with single-level and/or no firming are unable to exploit this form of dynamic responsiveness to problem space manipulations to its full extent.

While FIG. 1 illustrates various actions occurring in serial, it is to be appreciated that various actions illustrated in FIG. 1 could occur substantially in parallel. By way of illustration, a first process could access transportation planning elements and a second process could access a transportation planning model. Additionally, a third process could identify loads and/or shipments, a fourth process could assign multi-level firming designations, a fifth process could update transportation planning elements, and a sixth process could identify additional loads and/or shipments. While six processes are described, it is to be appreciated that a greater and/or lesser number of processes could be employed and that lightweight processes, regular processes, threads, and other approaches could be employed.

In one example, methodologies may be implemented as processor executable instructions and/or operations stored on a computer-readable medium. Thus, in one example, a computer-readable medium may store processor executable instructions operable to perform a method that includes accessing a set of transportation planning elements that includes data concerning items like an order, a shipment, a load, an order requirement, and so on. The method may also include accessing a transportation planning model that includes data concerning items like, a route, a carrier, a constraint, a preference, a rule, a rate, a facility, a transportation network, and so on. The method may also include identifying loads that satisfy orders in the set of transportation planning elements subject to rules in the transportation planning model and subject to order requirements. The method may also include assigning a multi-level firming designation to transportation planning elements associated with the loads and updating the set of transportation planning elements with the loads. The method may also include identifying additional loads that satisfy remaining orders in the set of transportation planning elements subject to rules in the transportation planning model, order requirements, and multi-level firming designations and providing an actionable plan of loads from the set of transportation planning elements. While the above method is described being stored on a computer-readable medium, it is to be appreciated that other example methods described herein can also be stored on a computer-readable medium.

FIG. 2 illustrates an example method 200 associated with transportation planning with multi-level firming. Method 200 may include actions 210 through 270 like those described in association with FIG. 1. Method 200 may also include, at 260, performing additional processing when identifying additional loads and/or shipments. For example, at 260, identifying an additional load and/or shipment may also include dynamically selecting an algorithm(s) to perform the consolidating, the assigning, the route determining, and/or the itinerary determining based, at least in part, on multi-level firming designations associated with transportation planning elements. By way of illustration, if the transportation planning elements contain a high ratio of firmed elements, then a look ahead algorithm with a larger big O (e.g., O(n²)) may be selected while if there is a low ratio of firmed elements, then a greedy algorithm with a smaller big O (e.g., O(n)) may be selected.

Method 200 may also include, at 280, selectively providing data concerning a load(s) to an execution process and designating the load(s) as routing and contents firm in the set of transportation planning elements. In one example, the execution process may be configured to execute substantially in parallel with the actions 210 through 270. Thus, while method 200 continues identifying loads and/or shipments, the execution process may be taking actions like tendering loads to carriers, establishing contracts with carriers who accept the tenders, logically removing load data from consideration for re-optimization, and so on. Thus, the overall amount of time spent in transportation planning may be reduced by this parallel processing.

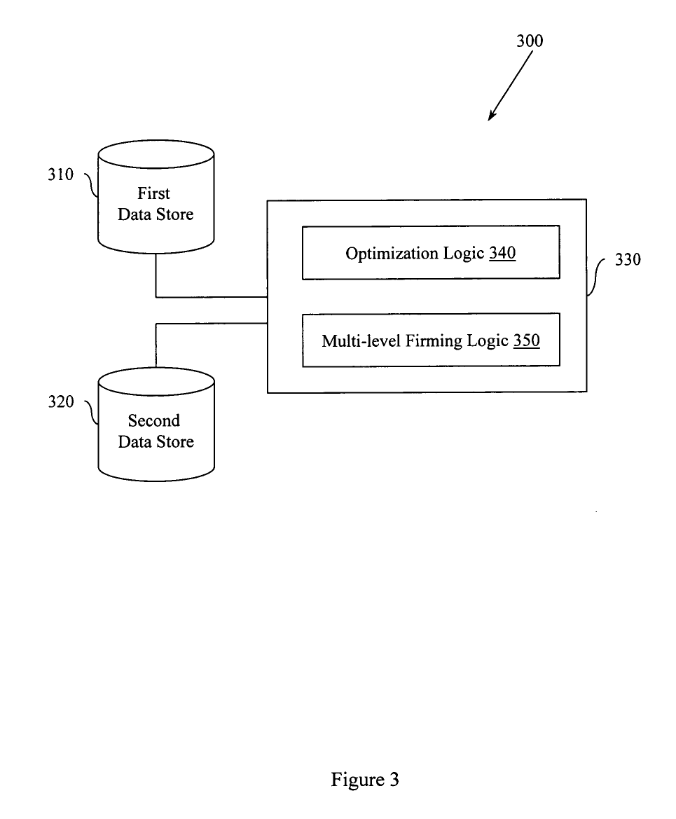

FIG. 3 illustrates an example system 300 associated with transportation planning with multi-level firming. System 300 may include a first data store 310 that is configured to store transportation planning data. The transportation planning data may describe, for example, an order, a shipment, a load, an order requirement, and so on. The order, shipment, load, and so on may be assigned a configurable multi-level immutability setting. For example, a load may be described as routing and contents firm, routing firm, and so on. Similarly, a shipment may be described as routing firm, and so on. Assigning a configurable multi-level immutability setting may include, for example, manipulating a value in the first data store 310. For example, transportation planning elements may be stored as records that include an immutability field. While records are described, it is to be appreciated that other data structures and association methods may be employed.

System 300 may also include a second data store 320 that is configured to store a transportation planning model. The transportation model may store data concerning items like a transportation network, a carrier, a route, a transportation planning rule, a transportation planning preference, and so on. The rules, constraints, and preferences may facilitate determining, for example, carriers and routes for a load that will satisfy orders described in the first data store 310. Thus, both the transportation planning data stored in the first data store 310 and the transportation planning model stored in the second data store 320 may be inputs to a transportation planning logic 330.

System 300 may include a transportation planning logic 330 that is operably connected to the first data store 310 and the second data store 320. Transportation planning logic 330 may be configured to construct a load that satisfies orders in the transportation planning data subject to data (e.g., rules, preferences, constraints, transportation network, facility information) in the transportation planning model. Thus, transportation planning logic 330 may include an optimization logic 340 that is configured to consolidate orders into shipments, to assign orders and/or shipments to a vehicle, to select a route for a vehicle, to determine an itinerary for a vehicle, and so on. The itinerary may describe, for example, the time at which various stops are to be made in the load and which order(s) and/or shipment(s) are to be (un)loaded at the stop(s). In one example, the optimization logic 340 may be configured to make these decisions using processor executable instructions that implement a greedy algorithm, a divide and conquer algorithm, a look ahead algorithm, a linear programming algorithm, a branch and bound algorithm, a savings based algorithm, a heuristic based algorithm, a dynamic programming algorithm, and the like. As described above, these algorithms may be reconfigured to consider data with different levels of immutability in their decision making processes.

Transportation planning logic 330 may also include a multi-level firming logic 350 that is configured to manipulate configurable multi-level immutability settings for transportation planning elements like orders, shipments, loads, and so on. In one example, the multi-level firming logic 350 may be configured to manipulate the configurable multi-level immutability settings in response to actions like a manual input and an automatic determination associated with constructing a load. By way of illustration, optimization logic 340 may present a set of candidate loads to a planner. The planner may accept certain of the loads and manually edit certain other of the loads. The accepting and/or manual editing may cause multi-level firming designations associated with transportation planning elements to be applied and/or manipulated. Additionally, and/or alternatively, the multi-level firming logic 350 may automatically manipulate the multi-level firming designations. In another example, the multi-level firming logic 350 may be configured to logically remove a transportation planning data element from active consideration by the optimization logic 340 for consolidation, assignment, routing, scheduling, and so on. The data may be logically removed, for example, by manipulating a configurable multi-level immutability setting for the transportation planning data element. In the example, the optimization logic 340 may be configured to also identify additional loads that satisfy remaining orders after the transportation planning data element has been logically removed from consideration. In this way, the amount of data to be considered by the optimization logic 340 is reduced as loads are identified and their associated data logically removed. In different examples, this may facilitate producing transportation plans with higher vehicle utilization, lower overall cost, and so on. Furthermore, in other examples this may facilitate more quickly responding to dynamic situations like receiving additional orders and having orders cancelled. Since certain loads may be firmed, the additional orders and/or cancelled orders can be processed by the optimization logic 340 without affecting the optimized and firmed loads. However, the data associated with the optimized and firmed loads may still be considered from certain points of view like dock capacity, minimum volume commitments, maximum vehicle availability, and so on.

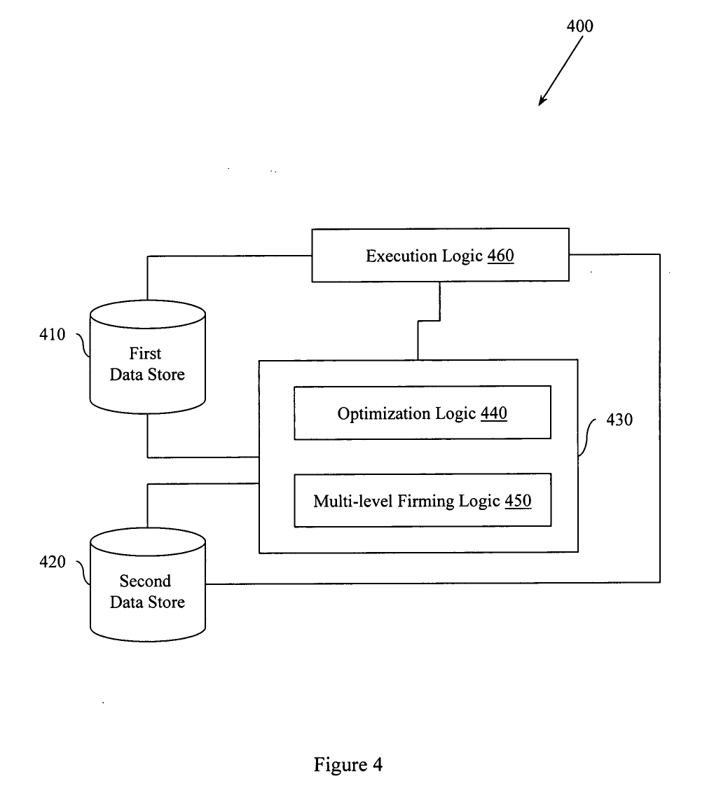

FIG. 4 illustrates an example system 400 associated with transportation planning with multi-level firming. System 400 may include elements 410 through 450 that are similar to elements 310 through 350 in FIG. 3. System 400 may also include an execution logic 460 that is configured to perform actions like tendering a load to a carrier, tracking a load, removing a load from the transportation planning data upon completion, and so on. Execution logic 460 facilitates parallel processing in transportation planning. Conventionally, planning may be an all or nothing proposition where a plan is made and then a plan is communicated and executed. However, with multi-level firming designations, parallelization may be employed wherein certain highly optimized and/or firmed loads may be presented to execution logic 460 for communication to carriers. As loads are tendered, started, completed, and so on, execution logic 460 may logically remove and/or physically remove data from the first data store 410 to reflect the completion status.

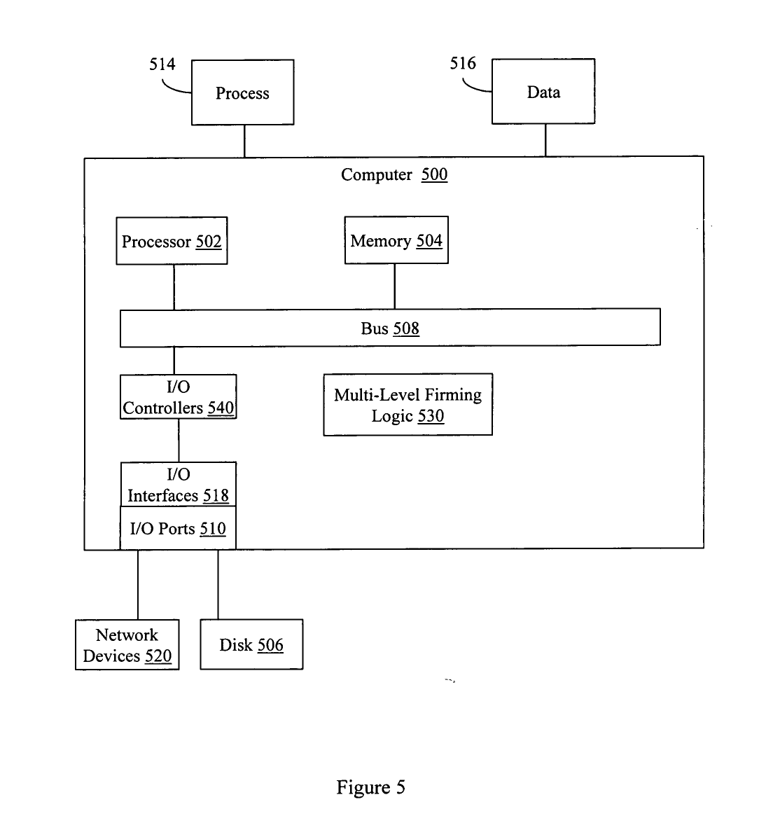

FIG. 5 illustrates an example computing device in which example systems and methods described herein, and equivalents, can operate. The example computing device may be a computer 500 that includes a processor 502, a memory 504, and input/output ports 510 operably connected by a bus 508. In one example, the computer 500 may include a multi-level firming logic 530 that is configured to facilitate transportation planning with multi-level firming. Multi-level firming logic 530 may implement portions of example systems described herein and may execute portions of example methods described herein. Thus, whether implemented in hardware, software, firmware, and/or combinations thereof, multi-level firming logic 530 and computer 500 may provide means for assigning an immutability level to an element of a load and means for constructing a load based, at least in part, on the immutability level of an element(s) of the load. As described above, a load may include, for example, a vehicle, a contents, a source, a destination, a route, an itinerary and so on. While multi-level firming logic 530 is illustrated in computer 500, it is to be appreciated that in some examples multi-level firming logic 530 may be replicated and/or distributed between, for example, disk 506 and memory 504.

Generally describing an example configuration of computer 500, processor 502 can be a variety of various processors including dual microprocessor and other multi-processor architectures. Memory 504 can include volatile memory and/or non-volatile memory. Disk 506 may be operably connected to computer 500 via, for example, an input/output interface (e.g., card, device) 518 and an input/output port 510. Disk 506 can include, but is not limited to, devices like a magnetic disk drive, a solid state disk drive, a floppy disk drive, a tape drive, a Zip drive, a flash memory card, and/or a memory stick. Furthermore, disk 506 can include optical drives like a CD-ROM, a CD recordable drive (CD-R drive), a CD rewriteable drive (CD-RW drive), and/or a digital video ROM drive (DVD ROM). The memory 504 can store processes 514 and/or data 516, for example. Disk 506 and/or memory 504 can store an operating system that controls and allocates resources of computer 500.

Bus 508 can be a single internal bus interconnect architecture and/or other bus or mesh architectures. While a single bus is illustrated, it is to be appreciated that computer 500 may communicate with various devices, logics, and peripherals using other busses that are not illustrated (e.g., PCIE, SATA, Infiniband, 1394, USB, Ethernet).

Computer 500 may interact with input/output devices via i/o interfaces 518 and input/output ports 510. Input/output devices can include, but are not limited to, a keyboard, a microphone, a pointing and selection device, cameras, video cards, displays, disk 506, network devices 520, and the like. Input/output ports 510 can include but are not limited to, serial ports, parallel ports, and USB ports.

Computer 500 can operate in a network environment and thus may be connected to network devices 520 via i/o devices 518, and/or i/o ports 510. Through network devices 520, computer 500 may interact with a network. Through the network, computer 500 may be logically connected to remote computers. The networks with which computer 500 may interact include, but are not limited to, a local area network (LAN), a wide area network (WAN), and other networks. Network devices 520 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, network devices 520 can connect to WAN technologies including, but not limited to, point to point links, circuit switching networks like integrated services digital networks (ISDN), packet switching networks, and digital subscriber lines (DSL).

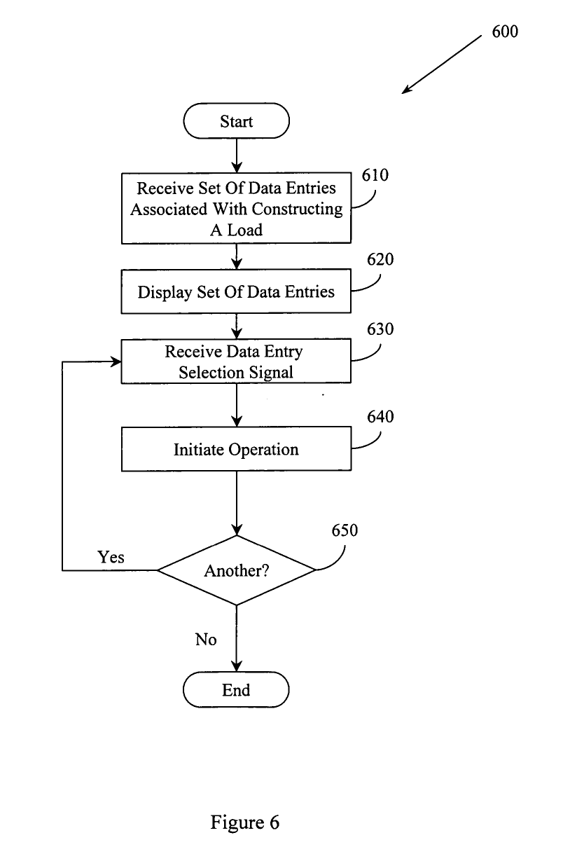

FIG. 6 illustrates an example method 600 associated with an example graphical user interface used in transportation planning systems and methods that employ multi-level firming. Method 600 may be performed by a system that includes a display and a selection device (e.g., mouse, keyboard). Method 600 may facilitate providing and selecting from a set of data entries on the display. Method 600 may include, for example, at 610, retrieving a set of data entries that represent actions associated with constructing a load based, at least in part, on an immutability level associated with a load element(s). Method 600 may also include, at 620, displaying the set of data entries on the display, at 630, receiving a data entry selection signal indicative of the selection device selecting a selected data entry, and in response to the data entry selection signal, at 640, initiating an operation associated with the selected data entry. Actions initiated at 640 may include, for example, firming a load, accepting an automated firming decision made by an example system, and the like.

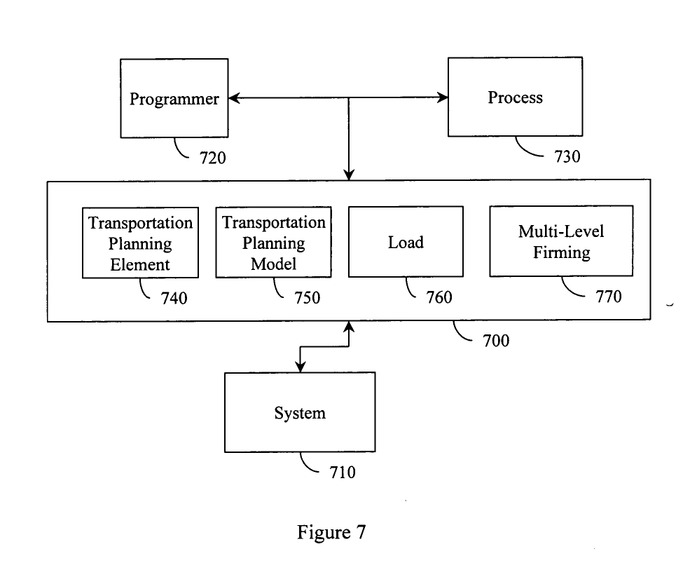

Referring now to FIG. 7, an application programming interface (API) 700 is illustrated providing access to a system 710 for transportation planning with multi-level firming. The API 700 can be employed, for example, by a programmer 720 and/or a process 730 to gain access to processing performed by the system 710. For example, a programmer 720 can write a program to access the system 710 (e.g., invoke its operation, monitor its operation, control its operation) where writing the program is facilitated by the presence of the API 700. Rather than programmer 720 having to understand the internals of the system 710, the programmer 720 merely has to learn the interface to the system 710. This facilitates encapsulating the functionality of the system 710 while exposing that functionality.

API 700 can be employed to provide data values to system 710 and/or retrieve data values from system 710. For example, a process 730 that identifies loads can provide load data to system 710 via API 700 by, for example, using a call provided in API 700. Thus, in one example of API 700, a set of application programming interfaces embodied on a computer-readable medium for execution by a computer component in conjunction with optimizing transportation planning with multi-level firming may be provided. The interfaces may include a first interface 740 for communicating a transportation planning element data like a load, an order, a shipment, and so on. The interfaces may also include a second interface 750 for communicating a transportation planning model data like a facility data, a transportation network data, and so on. The interfaces may also include a third interface 760 for communicating a load data like a route data, an itinerary data, and so on. The interfaces may also include a fourth interface 770 for communicating a multi-level firming data like an immutability level (e.g., routing and contents firm, routing firm, contents firm). While four example interfaces are illustrated, it is to be appreciated that a greater and/or lesser number of interfaces may be employed.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A computer-implemented method, comprising:
accessing a set of transportation planning elements that includes data concerning one or more of, an order, a shipment, a load, and an order requirement;
accessing a transportation planning model that includes data concerning one or more of, a route, a carrier, a constraint, a preference, a rule, a rate, a facility, and a transportation network;
identifying one or more loads and one or more shipments that satisfy one or more orders in the set of transportation planning elements subject to one or more rules in the transportation planning model and subject to one or more order requirements;
assigning a multi-level firming designation to one or more transportation planning elements associated with the one or more loads and one or more shipments;
updating the set of transportation planning elements with the one or more loads and the one or more shipments;
identifying one or more additional loads and one or more additional shipments that satisfy one or more remaining orders in the set of transportation planning elements subject to one or more rules in the transportation planning model, one or more order requirements, and one or more multi-level firming designations; and
providing an actionable plan of loads and consolidated shipments from the set of transportation planning elements.

2. The method of claim 1, the set of transportation planning elements being dynamically reconfigurable during method execution with one or more of, an additional order, an order cancellation, and a change in an order requirement.

3. The method of claim 2, where an order cancellation may cause a multi-level firming designation associated with a transportation planning element to be changed.

4. The method of claim 1, where identifying a load and a shipment includes applying one or more of, a greedy algorithm, a divide and conquer algorithm, a look ahead algorithm, a dynamic programming algorithm, a branch and bound algorithm, a savings based algorithm, a heuristic based algorithm, and a linear programming algorithm to perform one or more of, consolidating orders into shipments, assigning one or more orders and one or more shipments to a vehicle, determining a route for a vehicle, and determining an itinerary for a vehicle.

5. The method of claim 1, where an order requirement describes one or more of, an earliest pickup time, an earliest delivery time, a latest pickup time, a latest delivery time, a source, and a destination.

6. The method of claim 1, where identifying an additional load and an additional shipment includes applying one or more of, a greedy algorithm, a divide and conquer algorithm, a look ahead algorithm, a dynamic programming algorithm, a branch and bound algorithm, a savings based algorithm, a heuristic based algorithm, and a linear programming algorithm to perform one or more of, consolidating orders into shipments, assigning one or more orders and one or more shipments to a vehicle, determining a route for a vehicle, and determining an itinerary for a vehicle.

7. The method of claim 6, where identifying an additional load and an additional shipment includes dynamically selecting one or more algorithms to perform the consolidating, the assigning, the route determining, and the itinerary determining, where the selecting is based, at least in part, on one or more multi-level firming designations associated with one or more transportation planning elements.

8. The method of claim 1, the actionable plan including data concerning one or more of, a load contents, a load route, and a load itinerary.

9. The method of claim 1, where providing the actionable plan includes selectively providing data concerning one or more loads to an execution process and designating the one or more loads as routing and contents firm in the set of transportation planning elements.

10. The method of claim 9, the execution process being configured to execute substantially in parallel with the method of claim 1.

11. The method of claim 1, where a transportation planning element may be designated as one or more of, routing and contents firm, routing firm, contents firm, routing firm with removal of shipment not allowed, soft firm, and not firm.

12. The method of claim 1, including selectively manipulating one or more multi-level firming designations to produce mutual consistency for multi-level firming designations for one or more related orders, shipments, and loads.

13. The method of claim 1, the actionable plan of loads being stored on a computer-readable medium.

14. The method of claim 1 being stored as computer-executable instructions on a computer-readable medium.

15. A computer-implemented method, comprising:
accessing a set of transportation planning elements that includes data concerning one or more of, an order, a shipment, a load, and an order requirement, the set of transportation planning elements being dynamically reconfigurable during method execution with one or more of, an additional order, an order cancellation, and an order requirement change, where a dynamic reconfiguration may cause a multi-level firming designation associated with a transportation planning element to be changed;
accessing a transportation planning model that includes data concerning one or more of, a route, a carrier, a constraint, a preference, a rule, a rate, a facility, and a transportation network;
identifying one or more loads that satisfy one or more orders in the set of transportation planning elements subject to one or more rules in the transportation planning model and subject to one or more order requirements, where identifying a load includes applying one or more of, a greedy algorithm, a divide and conquer algorithm, a look ahead algorithm, a dynamic programming algorithm, a branch and bound algorithm, a savings based algorithm, a heuristic based algorithm, and a linear programming algorithm to perform one or more of, consolidating orders into shipments, assigning one or more orders and one or more shipments to a vehicle, determining a route for a vehicle, and determining an itinerary for a vehicle;
assigning a multi-level firming designation to one or more transportation planning elements associated with the one or more loads;
updating the set of transportation planning elements with the one or more loads;
identifying one or more additional loads that satisfy one or more remaining orders in the set of transportation planning elements subject to one or more rules in the transportation planning model, one or more order requirements, and one or more multi-level firming designations, where identifying an additional load includes dynamically selecting one or more algorithms to perform one or more of, consolidating orders into shipments, assigning orders and shipments to a vehicle, determining a route for a vehicle, and determining an itinerary for a vehicle where the selecting is based, at least in part, on one or more multi-level firming designations associated with one or more transportation planning elements; and
providing an actionable plan of loads and consolidated orders from the set of transportation planning elements, where providing the actionable plan includes selectively providing data concerning one or more loads to an execution process and designating the one or more loads as routing and contents firm in the set of transportation planning elements.

16. A computer-based system, comprising:
a first data store configured to store a transportation planning data that describes one or more of, an order, a shipment, a load, and an order requirement, where an order, a shipment, and a load may be assigned a configurable multi-level immutability setting;
a second data store configured to store a transportation planning model that stores data concerning one or more of, a transportation network, a carrier, a route, a transportation planning rule, and a transportation planning preference; and
a transportation planning logic operably connected to the first data store and the second data store, the transportation planning logic being configured to construct a load subject to data in the transportation planning model, the transportation planning logic comprising:
an optimization logic configured to consolidate one or more orders into one or more shipments, to assign one or more orders and one or more shipments to a vehicle, to select a route for a vehicle, and to determine an itinerary for a vehicle; and
a multi-level firming logic configured to manipulate the configurable multi-level immutability setting for one or more orders, shipments, and loads.

17. The system of claim 16, the multi-level firming logic being configured to manipulate the configurable multi-level immutability settings in response to one or more of, a manual input, and an automatic determination associated with constructing a load.

18. The system of claim 17, the optimization logic being configured to employ one or more of, a greedy algorithm, a divide and conquer algorithm, a look ahead algorithm, a dynamic programming algorithm, a branch and bound algorithm, a savings based algorithm, a heuristic based algorithm, and a linear programming algorithm to perform one or more of, consolidating orders into shipments, assigning orders and shipments to a vehicle, determining a route for a vehicle, and determining an itinerary for a vehicle.

19. The system of claim 18, the multi-level firming logic being configured to logically remove a transportation planning data element from active consideration for one or more of, consolidation, assignment, routing, and scheduling by the optimization logic by manipulating a configurable multi-level immutability setting for the transportation planning data element, and
the optimization logic being configured to identify one or more additional loads after the transportation planning data element has been logically removed from consideration.

20. The system of claim 19, including an execution logic configured to perform one or more of, tendering a load to a carrier, tracking a load, and removing a load from the transportation planning data upon completion.

21. The system of claim 16, the multi-level firming logic being configured to selectively manipulate one or more multi-level firming designations to produce mutual consistency for multi-level firming designations for one or more related orders, shipments, and loads.

22. A system, comprising:
means for assigning an immutability level to an element of a load, where a load includes one or more of, a vehicle, a contents, a source, a destination, a route, and an itinerary;
means for assigning an immutability level to an element of a shipment, where a shipment includes one or more of, an order, and an assigned load; and
means for constructing a load based, at least in part, on the immutability level of one or more elements of the load.

23. In a computer system having a graphical user interface comprising a display and a selection device, a method of providing and selecting from a set of data entries on the display, the method comprising:
retrieving a set of data entries, where a data entry represents an action associated with constructing a load based, at least in part, on an immutability level of one or more elements of a load;
displaying the set of data entries on the display;
receiving a data entry selection signal indicative of the selection device selecting a selected data entry; and
in response to the data entry selection signal, initiating an operation associated with the selected data entry.

24. A set of application programming interfaces embodied on a computer-readable medium for execution by a computer component in conjunction with optimizing transportation planning with multi-level firming, comprising:
a first interface for communicating a transportation planning element data;
a second interface for communicating a transportation planning model data;
a third interface for communicating a load data; and
a fourth interface for communicating a multi-level firming data.
